(19) United States
(12) Patent Application Publication
(10) Pub. No.: US 2016/0346867 A1
(43) Pub. Date: Dec. 1, 2016

(54) Method Of Joining Dissimilar Materials

(71) Applicants: John Hill, Shelby Township, MI (US); Gianfranco Gabbianelli, Birmingham, MI (US); James Byrne, II, Shelby Township, MI (US); Jaswinder Singh, Sterling Heights, MI (US); Mari Chellman, Berkley, MI (US); Randy Beals, Grand Ledge, MI (US)

(72) Inventors: John Hill, Shelby Township, MI (US); Gianfranco Gabbianelli, Birmingham, MI (US); James Byrne, II, Shelby Township, MI (US); Jaswinder Singh, Sterling Heights, MI (US); Mari Chellman, Berkley, MI (US); Randy Beals, Grand Ledge, MI (US)

(21) Appl. No.: 15/117,619

(22) PCT Filed: Feb. 11, 2015
(86) PCT No.: PCT/US2015/015437

§ 371 Date: Aug. 9, 2016

Related U.S. Application Data
(60) Provisional application No. 61/938,367, filed on Feb. 11, 2014.

(51) Int. Cl. B23K 11/20; B23K 11/14

(52) U.S. Cl. CPC B23K 11/20; B23K 11/14; B23K 2201/006

(57) ABSTRACT

The invention provides a method of joining dissimilar materials, such as aluminum to steel, by applying low pressure and heat to minimize distortion of the materials and the heat affected zone. The method includes applying current to a weld element, at least partially melting a portion of the first material with the heated weld element, and passing through the at least partially melted portion of the first material with the weld element. The method further includes contacting the second material with the heated weld element, and melting a portion of the weld element and a portion of the second material in contact with one another to form a weld. The weld element is designed with a head to trap the first material between the head and the second material, and a vent for receiving the at least partially melted first material as the weld element passes through.

### CROSS-REFERENCE TO PRIOR APPLICATIONS

This PCT Patent Application claims the benefit of U.S. Provisional Patent Application Ser. No. 61/938,367 filed Feb. 11, 2014, entitled “Method Of Joining Dissimilar Materials,” the entire disclosure of the application being considered part of the disclosure of this application and hereby incorporated by reference.

### BACKGROUND OF THE INVENTION

1. Technical Field

The invention relates generally to a method of joining dissimilar materials, a system for joining the dissimilar materials, and a structure including the joined dissimilar materials.

2. Related Art

Structural components for automotive vehicles, such as beams, pillars, and rails, oftentimes comprise dissimilar materials, for example a first material having a higher strength and a second material having a higher ductility. Various methods can be used to join the dissimilar materials together, for example welding or riveting. One welding technique used to join dissimilar materials is insert welding. This technique includes forcing a rivet through the first material and welding the rivet to the second material.

However, the known methods for joining dissimilar materials have drawbacks related to process time, reliability, quality, and/or costs. For example, welding becomes a challenge when the materials have significantly different melting points and thermal expansion coefficients, such as aluminum and steel. Insert welding also requires high loads, which means expensive equipment and possibly significant damage to the materials being joined. Also, many welding techniques require access to opposing sides of the materials to be joined, which is not possible in some cases.

### SUMMARY OF THE INVENTION

The invention provides a method of joining dissimilar materials using a weld element with reduced pressure and heat, and thus minimal distortion of the materials and reduced costs. The method includes disposing a first material along a second material, the first and second materials being dissimilar. The method further includes disposing a weld element along the first material, wherein the weld element includes a vent extending from a first end to a second end, and applying current to the weld element to heat the weld element. The method then includes at least partially melting a portion of the first material and passing through the at least partially melted portion of the first material with the heated weld element. The at least partially melted portion of the first material can enter the second end of the vent and flow toward the first end of the vent as the heated weld element passes through the first material. After passing through the at least partially melted portion of the first material, the method includes contacting the second material with the heated weld element, and melting a portion of the weld element and a portion of the second material in contact with one another to form a weld.

The invention also provides a system for joining the dissimilar materials. The system includes the first material disposed along the second material, and the weld element including the vent disposed along the first material. An energy source is connected to a primary electrode, and the energy source applies current to the primary electrode while the primary electrode engages the weld element. The heated weld element at least partially melts a portion of the first material, passes through the at least partially melted portion of the first material, and contacts the second material. A portion of the weld element and a portion of the second material in contact with one another melt to form the weld.

The invention further provides a structure including the dissimilar materials joined together with the weld element. The first material is disposed along the second material, and the weld element extends through the first material. The weld element extends along a center axis from a first end to a second end, and the second end is welded to the second material. The weld element also includes a vent extending along the center axis from the first end to the second end, and the vent may contain a re-solidified portion of the first material.

### BRIEF DESCRIPTION OF THE DRAWINGS

FIG. 1 illustrates five phases of an exemplary method for joining dissimilar materials with a weld element;

FIG. 1A is a side cross-sectional view of the dissimilar materials and the weld element during the second-fourth phases shown in FIG. 1;

FIG. 2 is a side cross-sectional view of another embodiment wherein more than two dissimilar materials are joined using the weld element;

FIG. 3 is a top view of the weld element according to an exemplary embodiment, wherein an outer surface of the weld element presents a circular shape and a head of the weld element is keyed;

FIG. 4 is a top view of the weld element according to another embodiment, wherein the outer surface presents a hexagonal shape;

FIG. 5 is a top view of the weld element according to yet another embodiment, wherein the outer surface presents a rectangular shape;

FIG. 6 is a side cross-sectional view of the weld element according to another embodiment with a chamfered first end and a vent width decreasing from the first end to the second end;

FIG. 7 is a side cross-sectional view of the weld element according to yet another embodiment with a sharp first end and a vent width decreasing from the first end to the second end;

FIG. 8 is a side cross-sectional view of the dissimilar materials and the weld element according to an another embodiment, wherein the weld element is disposed at an edge of the first material;

FIG. 8A is a top view of the dissimilar materials and the weld element of FIGS. 8; and

FIG. 9 is a side cross-sectional view of the dissimilar materials and the weld element according to yet another embodiment, wherein the head of the weld element is pressed into the first material.

### DESCRIPTION OF ENABLING EMBODIMENTS

The invention provides an improved method of joining dissimilar first and second materials 20, 22, such as aluminum to steel, with low pressure and heat, and thus low costs and minimal distortion of the materials 20, 22. The method includes at least partially melting through the first material 20 and contacting the second material 22 with a heated weld element 24. A connection 28 is formed between the weld element 24 and the first material 20, and a metallurgical bond, i.e. weld 26, is formed between the weld element 24 and the second material 22. Preferably, the geometry of the weld element 24 is designed to trap the first material 20 between the weld element 24 and the second material 22, i.e. to create an in-situ mechanical bond, once the weld 26 is in place.

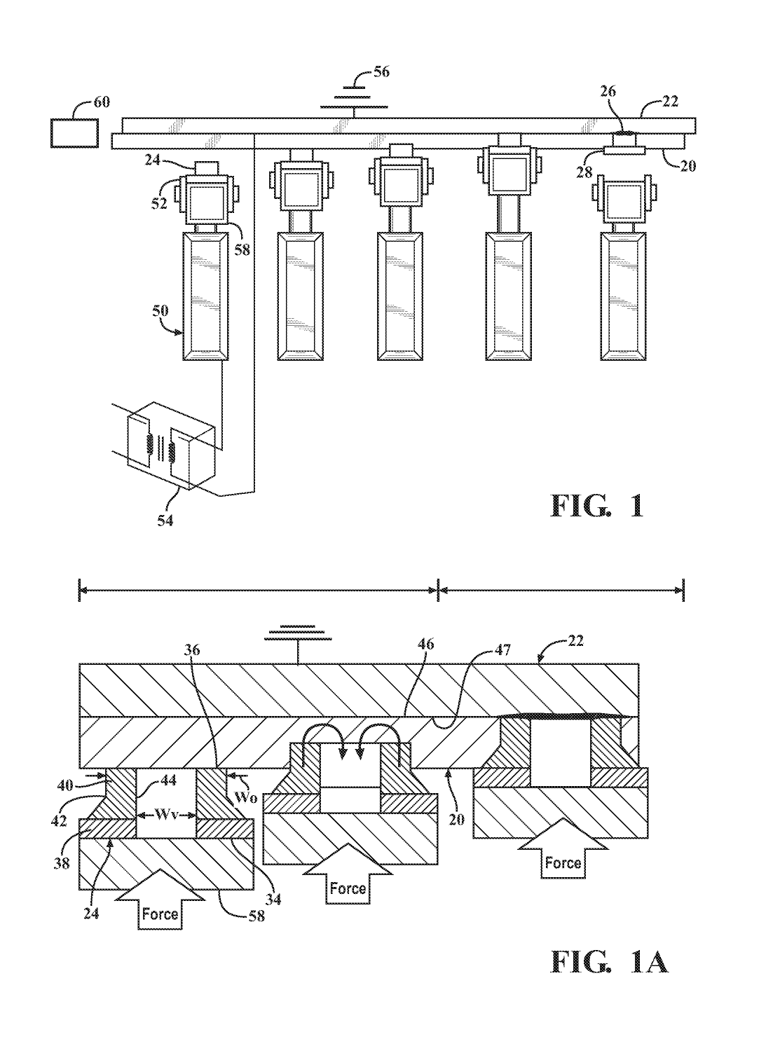

An exemplary embodiment of the method is generally illustrated in FIG. 1. The method first includes providing the first material 20 and the second material 22. Typically, both of the materials 20, 22 are provided in the form of a tube or sheet. The materials 20, 22 could also be castings of various different shapes. The size and dimensions of the materials 20, 22 can vary depending on the intended application of the product. In the exemplary embodiment, both materials 20, 22 are provided in the form of a sheet having a thickness t₁, t₂ of not greater than 2 millimeters. However, there is no limit to the thickness t₁, t₂ of the dissimilar materials 20, 22 that can be joined using the weld element 24, as the size and dimensions of the weld element 24 can be designed accordingly. For example, if the materials 20, 22 have a large thickness t₁, t₂, the length of the weld element 24 can be increased.

Various different material compositions can be joined by the weld element 24, but the first material 20 typically has a lower melting point and a lower electrical resistivity than the second material 22. The first material 20 is a non-ferrous based metal and/or a carbon fiber composite. In the exemplary embodiments, the first material 20 is an aluminum alloy or another aluminum-based material, for example the aluminum alloy sold under the designation 5182. The second material 22 is a ferrous-based metal. In the exemplary embodiment, the second material 22 is steel, for example the type of steel sold under the name 60G60G.

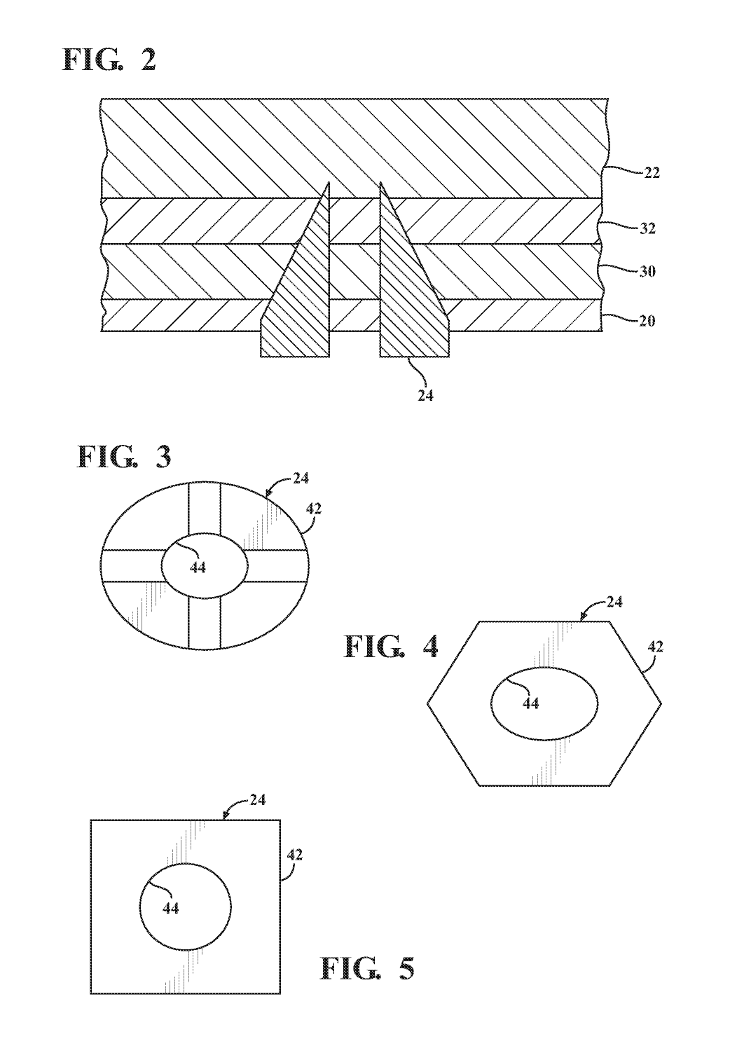

Although the exemplary embodiment of FIGS. 1 and 1A shows the weld element 24 joining only two dissimilar materials 20, 22 the method can alternatively including joining more than two dissimilar materials. FIG. 2 shows an example of four materials 20, 22, 30, 32 joined together by the weld element 24, wherein third and fourth materials 30, 32 are disposed between the first and second materials 20, 22. In this example, the third material 30 is formed of magnesium, and the fourth material 32 is formed of aluminum.

The method also begins by providing the weld element 24. In the exemplary embodiment shown in FIGS. 1 and 1A, the weld element 24 is a rivet extending longitudinally along a center axis A from a first end 34 to a second end 36. This weld element 24 includes a head 38 extending outwardly and perpendicular to the center axis A and a shaft 40 extending along the center axis A from the head 38 to the second end 36. The weld element 24 also includes an outer surface 42 facing away from the center axis A and presenting an outer width wₒ which extends perpendicular to the center axis A. The outer width wₒ at the first end 34 is typically greater than the outer width wₒ at the second end 36. In the exemplary embodiment, the outer width wₒ is greater along the head 38 than the shaft 40. The outer width wₒ is also constant along the entire head 38 from the first end 34 to the shaft 40, and constant along the entire shaft 40 from the head 38 to the second end 36. Alternatively, the outer width wₒ could taper continuously between the first end 34 and the second end 36, as shown in FIG. 2. In another embodiment, the head 38 of the weld element 24 is keyed, as shown in FIG. 3. The keyed feature on the head 38 can be used to conduct a non-destructive torque test and thus determine the strength of the weld element 24 joining the materials 20, 22 together. For example, a wrench can be used to engage the keyed head 38 and apply torque to the weld element 24 to measure the strength of the connection between the materials 20, 22.

The outer surface 42 of the weld element 24 can present various different shapes when viewed in cross-section. In one embodiment, the outer surface 42 of both the head 38 and the shaft 40 present a circular shape, as shown in FIG. 3. The outer surface 42 of the weld element 24 could alternatively present a hexagonal shape, as shown in FIG. 4, or a rectangular shape, as shown in FIG. 5. In addition, the head 38 and shaft 40 could present shapes which are different from one another.

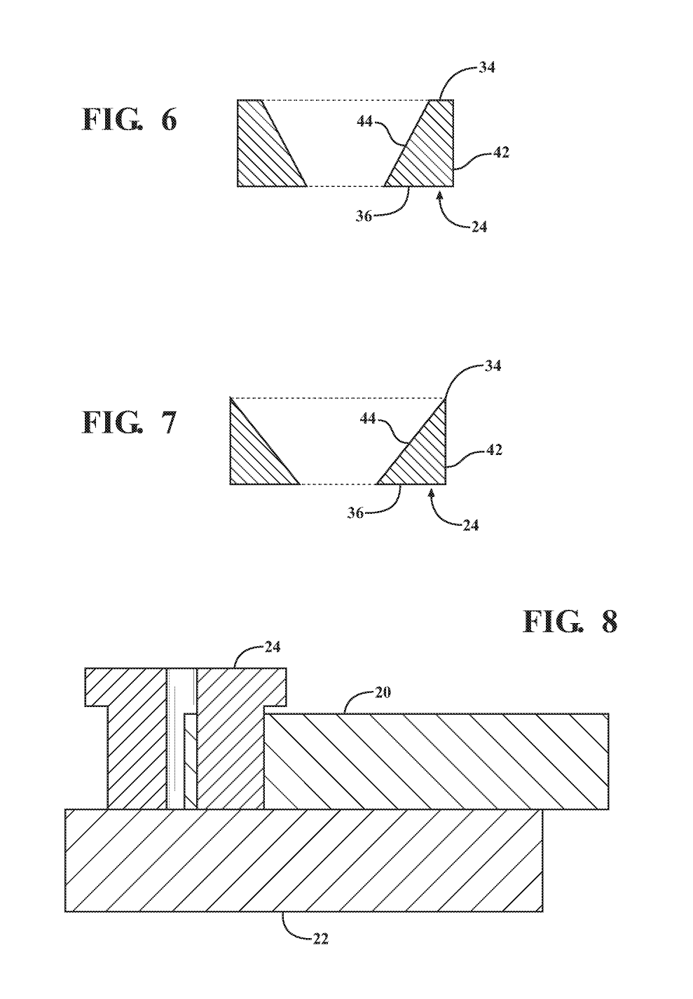

The weld element 24 also preferably includes an inner surface 44 presenting a vent extending along the center axis A and continuously from the first end 34 to the second end 36, as shown in FIGS. 1, 2, 6, and 7, so that while melting or partially melting through the first material 20, the at least partially melted portion of the first material 20 can enter the vent at the second end 36 and flow toward the first end 34 of the weld element 24. The outer surface 42 of the weld element 24 creates a cut line as it passes through the at least partially melted first material 20, which directs the at least partially melted first material 20 through the vent. The inner surface 44 of the weld element 24 presents a vent width Iv, extending perpendicular to the center axis A, which can vary depending on the desired flow of the at least partially melted first material 20. In the embodiment shown in FIGS. 1 and 2, the vent width wₒ is constant from the first end 34 to the second end 36. In the embodiment of FIGS. 6 and 7, the vent width w, is greater at the first end 34 than the second end 36. In another embodiment, the inner surface 44 of the weld element 24 includes threads along the vent for attachment of another component.

In addition, the ends 34, 36 of the weld element 24 can be flat or sharp. For example, in the embodiment of FIG. 1, both the first and second ends 34, 36 include a flat surface. In the embodiment of FIG. 2, the first end 34 is flat and the second end 36 is sharp. In the embodiment of FIG. 6, the first end 34 is chamfered to present a flat surface, and the second end 36 is also flat. In FIG. 7, the first end 34 is sharp and the second end 36 is flat.

The weld element 24 can be formed of various different materials, but is typically formed of a material having a melting point and electrical resistivity greater than the first material 20 and similar to the second material 22, for example steel or another iron-based material. In the exemplary embodiment, the weld element 24 is formed of steel sold under the name 1018 steel. In another embodiment, the weld element 24 is formed of a plurality of different materials. For example, the weld element 24 can include a layer of stainless steel disposed along the second end 36 while the remainder of the weld element 24 is formed of a ferrous-based material having a higher melting point and electrical resistance than the stainless steel. A coating can optionally be applied to the weld element 24. In one embodiment, the weld element 24 is electro-coated with a layer of stainless steel or an aluminum-based material, for example an aluminum alloy of the 4000 series.

Once the materials 20, 22 and weld element 24 are obtained, the method includes disposing a contact surface 46 of the first material 20 along and parallel to a contact surface 47 of the second material 22. The method can also include joining more than two dissimilar materials using the weld element 24. When additional materials are joined, the additional materials 30, 32 are also disposed along the first and second materials 20, 22, as shown in FIG. 2. In the exemplary embodiment shown in FIGS. 1 and 1A, the method includes disposing the second material 22 above the first material 20. This position assists in the flow of the at least partially melted first material 20 through the vent, and thus allows a lower pressure to be applied to the weld element 24.

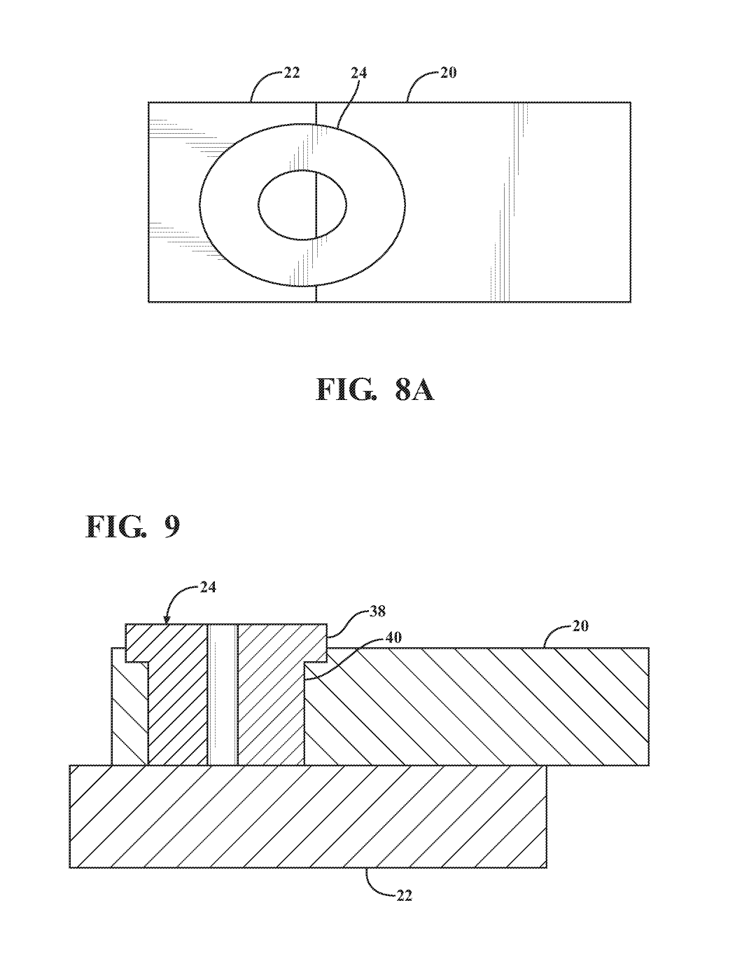

The method also includes disposing the second end 36 of the weld element 24 on an exposed surface 48 of the first material 20 opposite the contact surface 46 in preparation to join the materials 20, 22. An advantage provided by the method is that it only requires access to one side of the materials 20, 22 to be joined, not both sides as in other joining methods. In the exemplary embodiment shown in FIG. 1, a welding apparatus 50 with a holding device 52 places the weld element 24 on the first material 20. The weld element 24 is typically positioned along the first material 20 so that the entire outer surface 42 of the weld element 24 is surrounded by the first material 20 after the weld element 24 melts through or at least partially melts through the first material 20, as shown in FIGS. 1 and 2. However, the weld element 24 could be disposed along an edge of the first material 20, as shown in FIGS. 8 and 8A.

As alluded to above, the method next includes using the weld element 24 to melt or at least partially melt a portion of the first material 20, pass through the at least partially melted portion of the first material 20 with a low force, and form the weld 26 between the weld element 24 and the second material 22. This step includes applying current to the weld element 24 to heat the weld element 24 while applying a low pressure to the heated weld element 24. In the exemplary embodiment, the welding apparatus 50 includes a primary electrode 58 contacting the weld element 24, and an energy source 54 providing the current to the primary electrode 58 and the weld element 24. The second material 22 provides a ground for the primary electrode 58, which allows for one-sided access during the welding process. Alternatively, a separate ground electrode 56 may contact the second material 22 when the current is being applied.

In one embodiment, the energy source 54 is an AC transformer with a positive connection to the primary electrode 58. The AC transformer also provides a negative connection to the second material 22. In this example, the positive connection is approximately 480 VAC, and the negative connection is approximately 9 to 21 VAC. However, other types of energy sources 54, such as a DC transformer, can be used.

The step of applying the current to the weld element 24 typically includes applying a low current when melting or partially melting through the first material 20 with the weld element 24, and applying an equal or greater current once the weld element 24 contacts the second material 22 to form the weld 26 between the weld element 24 and the second material 22. For example, in the exemplary embodiment, the method includes providing the current from the transformer to the primary electrode 58 while the primary electrode 58 engages the first end 34 of the weld element 24 for a first duration of time followed by a second duration of time, wherein the current is greater during the second duration of time. The step of passing through the at least partially melted portion of the first material 20 occurs during the first duration of time. The first duration of time ends and the second duration of time begins when the second end 36 of the weld element 24 contacts the contact surface 47 of the second material 22. The step of forming the weld 26 between the weld element 24 and the second material 22 then occurs during the second duration of time.

A sensor 60 can be used to determine the location of the weld element 24 relative to at least one of the surfaces of the materials 20, 22 and thus determine when the second end 36 of the weld element 24 engages the contact surface 47 of the second material 22. The welding apparatus 50 continues moving the weld element 24 longitudinally into the at least partially melted portion of the first material 20 until the weld element 24 contacts the second material 22. Once the weld element 24 contacts the second material 22, the welding apparatus 50 stops pressing the weld element 24, or only presses the weld element 24 a very short distance into the melted portion of the second material 22, to form the weld 26. In the embodiments shown in FIGS. 1, 8, and 9, the head 38 of the weld element 24 traps the first material 20 between the head 38 and the second material 22, and the weld 26 metallurgically bonds the weld element 24 to the second material 22 to secure the weld element 24 and materials 20, 22 in position. The weld 26 has a high strength and fatigue, and thus is reliable for use in various automotive application, such as beams, pillars, and rails.

As mentioned above, the current applied during the second duration of time can be equal to or greater than the current applied during the first duration of time. In the exemplary embodiment, the current during the first duration of time reaches approximately 13-15 kA, and the current during the second duration of time is greater. The current can be increased sharply at the end of the first duration of time, or increased gradually and continuously from the first to the second duration of time. In addition, the current can be constant or vary during the first and second durations of time. In the exemplary embodiment, the method includes varying the current during the first duration of time and maintaining the current constant throughout the second duration of time.

Due to the different current levels applied, the method includes heating the weld element 24 to an equal or higher temperature during the second duration of time than the first duration of time. In the exemplary embodiment, the temperature of the weld element 24 is higher during the second duration of time. When the weld element 24 is formed of an iron-based material, the maximum temperature of the weld element 24 at any point during the method should not exceed 700° C., and is preferably just above 600° C. during the second duration of time to form the weld 26.

As mentioned above, the pressure is applied to the weld element 24 while the current is applied to move the heated weld element 24 through the at least partially melted portion of the first material 20. In the exemplary embodiment, this step includes applying a load to the primary electrode 58 while the primary electrode 58 engages and provides current to the weld element 24. The load applied to the weld element 24 is low compared to other methods used to join materials with a rivet. This low pressure minimizes distortion and prevents significant distortion of the first and second materials 20, 22 in the portions which are not melted or partially melted. Preferably, while passing through the at least partially melted portion of the first material 20 with the low force, the heated weld element 24 does not deform adjacent portions of the first material 20 which are not melted or partially melted by the heated weld element 24. In other words, the first and second materials 20, 22 are not forcibly penetrated, punctured, or pierced, as in other methods used to join dissimilar materials. Typically, the first and second material 20, 22 maintain the same shape throughout the welding process, except for the melted or partially melted portion of the first material 20 adjacent the weld element 24, and the weld 26 between the second material 22 and the weld element 24. In the exemplary embodiment, the load applied to the weld element 24 is not greater than 300 pounds and is maintained constant during the first duration of time and the second duration of time. Alternatively, the load can vary throughout either or both durations of time, but is still kept at a low value.

As discussed above, applying the current and low pressure to the heated weld element 24 melts or partially melts a portion of the first material 20 adjacent the second end 36 of the weld element 24. The at least partially melted first material 20 can flow into the vent at the second end 36 and through the vent toward the first end 34 of the weld element 24. However, in some cases, the first material 20 does not flow into the vent. Only a small portion of the first material 20 melts or partially melts, and the remaining portions remain solid. The at least partially melted first material 20 then solidifies around the weld element 24 and in the vent, which may prevent corrosion of the weld element 24 and materials 20, 22 disposed along the weld element 24. Once the second end 36 of the weld element 24 contacts the second material 22, the current is increased to melt a portion of the weld element 24 along the second end 36, as well as a portion of the second material 22 contacted by the second end 36 of the weld element 24. Only small portions of the weld element 24 and second material 22 melt, and the remaining portions remain solid. The melted portions solidify and form the weld 26.

In the exemplary embodiment shown in FIG. 1, the head 38 of the weld element 24 is pressed a short distance into the first material 20 and forms a connection 28 therebetween. Alternatively, the head 38 could contact and rest on the exposed surface 48 of the first material 20 to form the connection 28. In this case, the head 38 remains outward of the first material 20. The head 38 could alternatively be pressed past the exposed surface 48 and into the first material 20 in order to reduce corrosion along surfaces of the weld element 24. For example, the head 38 could be countersunk in the first material 20. In embodiments wherein the weld element 24 does not include the head 38, the first end 34 of the weld element 24 could be flush with the exposed surface 48 of the first material 20, remain outward of the exposed surface 48 of the first material 20, or pressed inward of the exposed surface 48 of the first material 20 to reduce corrosion. Once the weld 26 is formed, the welding apparatus 50 retracts and the method can be repeated.

As discussed above, the method of the present invention provides many advantages, including low pressure and heat, and thus low costs and minimal distortion of the first and second materials 20, 22, a small heat affected zone between the two materials 20, 22, a strong weld 26, and possibly corrosion resistance. In addition, the method only requires access to one side of the materials 20, 22 to be joined, and there is no limit to the thickness t of the materials 20, 22. Another advantage of the method is a fast cycle time. The first duration of time during which the weld element 24 passes through the first material 20 is typically less than 0.5 seconds. The second duration of time during which the weld 26 is formed is also typically less than 0.5 seconds. In the exemplary embodiment, the total time from when the weld element 24 begins to at least partially melt the first material 20 and the formation of the weld 26 is not greater than 0.8 seconds.

The invention also provides a system for joining dissimilar materials 20, 22, such as aluminum to steel, according to the method described above. An example of the system is shown in FIG. 1. The system includes the first and second materials 20, 22, the weld element 24, the welding apparatus 50, and the energy source 54. The energy source 54 is connected to the primary electrode 58 of the welding apparatus 50 and applies current to the primary electrode 58 while the primary electrode 58 engages and applies low pressure to the weld element 24. The heated weld element 24 at least partially melts a portion of the first material 20, passes through the at least partially melted portion of the first material 20 with low force, and contacts the second material 22. A portion of the weld element 24 and a portion of the second material 22 in contact with one another then melt to form the weld 26. The system can also include the sensor 60 determining when the weld element 24 contacts the second material 22, so that the energy source 54 can apply the greater current once the weld element 24 contacts the second material 22.

The invention also provides a structure including the dissimilar materials 20, 22 joined by the weld element 24 extending through the first material 20 and welded to the second material 22, according to the method described above. An example of the structure is shown in FIG. 1. The structure includes the first material 20 disposed along the second material 22. The first and second materials 20, 22 are dissimilar, for example, the first material 20 can be an aluminum-based material, and the second material 22 and the weld element 24 can be iron-based. The weld element 24 extends along a center axis A from the first end 34 to the second end 36. The first end 34 is disposed along the first material 20 and the second end 36 is welded to the second material 22. The weld element 24 also includes the vent extending along the center axis A from the first end 34 to the second end 36, and the vent contains a re-solidified portion of the first material 20.

Obviously, many modifications and variations of the present invention are possible in light of the above teachings and may be practiced otherwise than as specifically described while within the scope of the following claims.

1. A method of joining dissimilar materials, comprising the steps of:
disposing a first material along a second material, the first and second materials being dissimilar;
disposing a weld element along the first material, the weld element including a vent extending from a first end to a second end;
applying current to the weld element to heat the weld element;
at least partially melting a portion of the first material and passing through the at least partially melted portion of the first material with the heated weld element;
contacting the second material with the heated weld element after passing through the at least partially melted portion of the first material; and
melting a portion of the weld element and a portion of the second material in contact with one another to form a weld.

2. The method of claim 1 including trapping the first material between the weld element and the second material.

3. The method of claim 1, wherein the first material is a non-ferrous based metal, and the second material and the weld element are ferrous-based metals.

4. The method of claim 1, wherein the step of applying current includes applying the current for a first duration of time followed by a second duration of time, wherein the current during the second duration of time is equal or greater than the current during first duration of time, the step of passing through the at least partially melted portion of the first material occurs during the first duration of time, the first duration of time ends when the weld element contacts the second material, and the step of forming the weld between the weld element and the second material occurs during the second duration of time.

5. The method of claim 4 including varying the current during the first duration of time and maintaining the current constant during the second duration of time.

6. The method of claim 1, wherein the step of passing through the at least partially melted portion of the first material with the heated weld element includes applying pressure to the heated weld element at a level of not greater than 300 pounds.

7. The method of claim 1, wherein the weld element includes an outer surface facing away from a center axis and presenting an outer width extending perpendicular to the center axis, and the outer width is greater at the first end than the second end.

8. The method of claim 1, wherein the weld element includes a head extending outwardly from and perpendicular a center axis, and further including the step of contacting an exposed surface of the first material with the head of the weld element.

9. The method of claim 1, wherein the weld element includes a head extending outwardly from and perpendicular to a center axis at the first end, and the head of the weld element is keyed.

10. The method of claim 1 including disposing the second material above the first material while applying the current to the weld element.

11. The method of claim 1, wherein the step of applying the current includes providing the current from a transformer to a primary electrode while the primary electrode engages the weld element, and further including applying pressure to primary electrode while the primary electrode engages and provides current to the weld element.

12. The method of claim 1, wherein the first material is aluminum-based and comprises a sheet, tube, or casting,
the second material is iron-based and comprises a sheet, tube, or casting,
the weld element is iron-based and extends longitudinally along a center axis from a first end to a second end, the weld element includes a head extending outwardly from and perpendicular to the center axis, and the weld element includes a vent extending continuously along the center axis from the first end to the second end; and further including the steps of:
disposing a contact surface of the first material along and parallel to a contact surface of the second material;
disposing the second material above the first material;
disposing the second end of the weld element on an exposed surface of the first material opposite the contact surface;
the step of applying the current including providing the current from a transformer to a primary electrode while the primary electrode engages the first end of the weld element for a first duration of time followed by a second duration of time, wherein the step of passing through the at least partially melted portion of the first material occurs during the first duration of time, the first duration of time ends when the weld element contacts the second material, and the step of forming the weld between the weld element and the second material occurs during the second duration of time, the first duration of time being less than 0.5 seconds, and the second duration of time being less than 0.5 seconds;
the step of applying the current including applying a greater current during the second duration of time than the first duration of time;
the step of applying the current including varying the current during the first duration of time and maintaining the current constant throughout the second duration of time;
the step of applying the current including heating the weld element to a higher temperature during the second duration of time than the first duration of time;
contacting the second material with a ground electrode while applying the current;
determining the location of the weld element relative to at least one of the surfaces of the first material and the second material as the weld element passes through the first material to determine when the second end of the weld element contacts the second material;
beginning the second duration of time with the greater current once the second end of the weld element contacts the second material;
applying pressure to the weld element by applying a load to the primary electrode while the primary electrode engages and provides current to the weld element;
the step of applying the pressure to the weld element including maintaining the load constant during the first duration of time and the second duration of time;
contacting the exposed surface of the first material with the head of the weld element; and
trapping the first material between the head of the weld element and the second material.

13. A method of joining dissimilar materials, comprising the steps of:
disposing a first material along a second material, the first and second materials being dissimilar;
disposing a weld element along the first material, the weld element including a vent extending from a first end to a second end;
applying current to the weld element to heat the weld element;
at least partially melting a portion of the first material and passing through the at least partially melted portion of the first material with the heated weld element;
contacting the second material with the heated weld element after passing through the at least partially melted portion of the first material;
melting a portion of the weld element and a portion of the second material in contact with one another to form a weld; and
trapping the first material between the weld element and the second material to form a mechanical bond.

14. A system for joining dissimilar materials, comprising:
a first material disposed along a second material, the first and second materials being dissimilar;
a weld element disposed along the first material, the weld element including a vent extending from a first end to a second end;
an energy source connected to a primary electrode, wherein the energy source applies current to the primary electrode while the primary electrode engages the weld element, thereby heating the weld element to at least partially melt a portion of the first material, passing through the at least partially melted portion of the first material with the weld element, contacting the second material with the weld element, and melting a portion of the weld element and a portion of the second material in contact with one another to form a weld.

15. The system of claim 14 including a sensor determining when the weld element contacts the second material, and applying a greater current once the weld element contacts the second material.

16. A structure, comprising:
a first material disposed along a second material, the first and second materials being dissimilar;
a weld element extending through the first material, the weld element extending along a center axis from a first end to a second end, wherein the second end is welded to the second material; and
the weld element including a vent extending from the first end to the second end.

17. The structure of claim 16, wherein the first material is trapped between the weld element and the second material.

18. The structure of claim 17, wherein the weld element includes a head extending outwardly from the center axis for trapping the first material between the head of the weld element and the second material.

19. The method of claim 13, wherein the step of applying current includes applying the current for a first duration of time followed by a second duration of time, wherein the current during the second duration of time is equal or greater than the current during first duration of time, the step of passing through the at least partially melted portion of the first material occurs during the first duration of time, the first duration of time ends when the weld element contacts the second material, and the step of forming the weld between the weld element and the second material occurs during the second duration of time.

20. The method of claim 19 including varying the current during the first duration of time and maintaining the current constant during the second duration of time.
